(19) United States
(12) Patent Application Publication
(10) Pub. No.: US 2010/0185511 A1
(43) Pub. Date: Jul. 22, 2010

(54) Standalone Active Display Device for Advertising of Goods and Method of use thereof

(76) Inventor: David Nowacek, San Antonio, TX (US)

Correspondence Address: JACKSON WALKER, L.L.P., 112 E. PECAN, SUITE 2400, SAN ANTONIO, TX, 78205, US

(21) Appl. No.: 12/599,413

(22) PCT Filed: Apr. 24, 2008
(86) PCT No.: PCT/US08/05257

§ 371 Date: Nov. 9, 2009

Related U.S. Application Data
(60) Provisional application No. 60/925,995, filed on Apr. 24, 2007.

(51) Int. Cl. G06Q 30/00; G09G 5/00; G06T 15/70

(52) U.S. Cl. 705/14.49; 705/14.4; 345/204; 345/473

(57) ABSTRACT

An active display is adapted to advertise the goods displayed on a shelf. A high-aspect-ratio display screen is connected to a display controller, which provides a static or animated image to the display screen. The image may be periodically cycled. In some embodiments, a nearby camera captures images of a consumer near the display and superimposes the consumer's image onto the screen, creating the illusion of interaction with the scene portrayed.

### CROSS REFERENCE TO RELATED APPLICATIONS

This application claims the benefit of U.S. provisional application 60/925,995, which is incorporated herein by reference. Applicant's co-pending application “Multimedia Product Display” filed Apr. 24, 2008 is incorporated herein by reference.

### BACKGROUND

This specification relates to the field of retail advertisement and more particularly to a standalone active display for advertising goods.

Retailers and other sellers of goods commonly arrange their goods on display cases. These display cases often have shelves, and the shelves sometimes have a front face.

### BRIEF DESCRIPTION OF THE DRAWINGS

FIG. 1 is a plan view depicting selected elements of a retail store, including a plurality of shelves;

FIG. 2 is a front view of a shelf and an embodiment of an active display;

FIG. 3 depicts an embodiment of an active display, including mechanical mountings and electronic components;

FIG. 3A is a side view of shelves and active displays;

FIG. 4 is a top view of an embodiment of an active display with a lens assembly attached to it;

FIG. 5 is a perspective view depicting an embodiment of an active display with a video camera;

FIG. 6A is a top view of an embodiment of an active display wherein the display screen is straight;

FIG. 6B is a top view of an embodiment of an active display wherein the display screen is curved;

FIG. 6C is a front view of an embodiment of an active display wherein the display screen is in a tabular configuration;

FIG. 7 is a front view of an embodiment of an active display having a high aspect ratio;

FIG. 8 depicts an embodiment of an active display in which multiple active displays are used in conjunction with each other to form a contiguous image;

FIG. 9 is a block diagram of selected elements of an embodiment of a display controller suitable for use with an active display; and

FIG. 10 is a front view of selected elements of an embodiment of an active display suitable for use with a vending machine.

### SUMMARY OF THE INVENTION

In one aspect, a disclosed active display is a standalone device adapted to advertise goods displayed on a shelf. In some embodiments, the active display includes a high-aspect-ratio display screen connected to a display controller, which provides a static or dynamic image. The image may be periodically cycled. In some embodiments, a nearby camera captures images of a consumer near the active display and superimposes the consumer's image onto the screen, creating the illusion of interaction with the scene portrayed.

### DETAILED DESCRIPTION OF THE EMBODIMENTS

A standalone active display will now be described with more particular reference to the attached drawings. Hereafter, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance or example of an element and the un-hyphenated form of the reference numeral refers to the element generically or collectively. Thus, for example, 102-1 may refer to a “pen,” which may be an instance or example of the class of “writing implements.” Writing implements may be referred to collectively as “writing implements 102” and any one may be referred to generically as a “writing implement 102.”

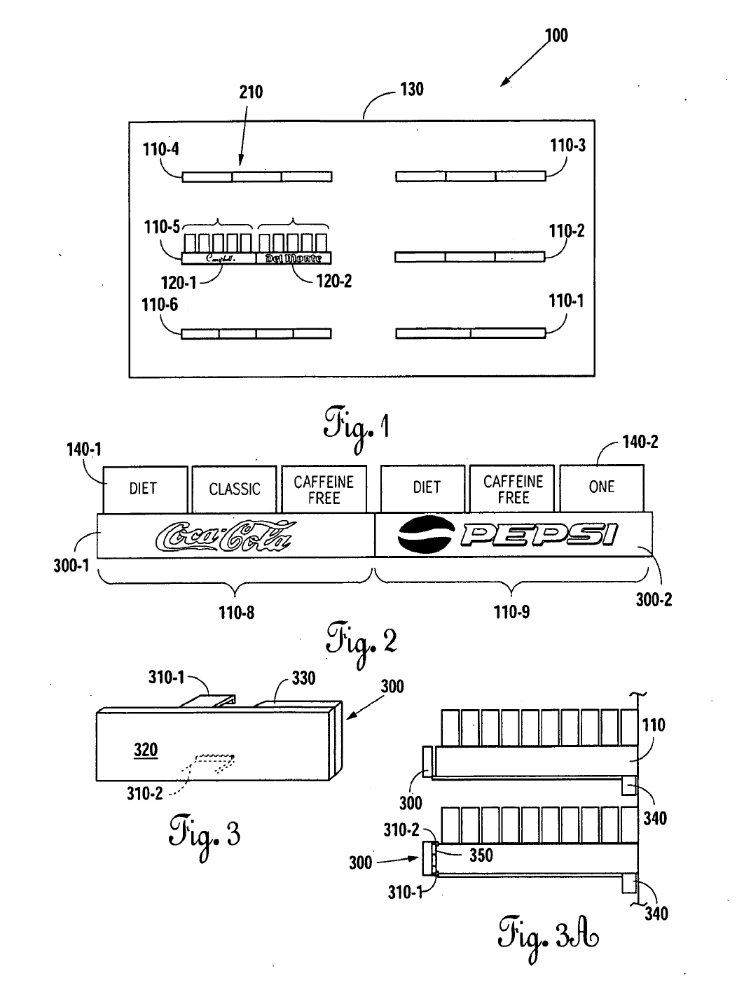

FIG. 1 is a plan view of selected elements of a retail store 130, including shelves 110. As depicted in FIG. 1, at least some of the shelves 110 are stocked with products 140. Each of the shelves 110 may have a front face 120 with a height and a width, and which can serve as a supporting surface for an active display 300 (FIG. 3). An active display 300 (FIG. 3) may have a height and a width selected so that the active display 300 (FIG. 3) may be mechanically coupled to a shelf 110. In some embodiments, an active display 300 (FIG. 3) may have a height and a width substantially conforming to the height and width of a shelf 110.

FIG. 2 is a more detailed view of shelves 110-8 and 120-9. Shelf 120-8 is configured to hold the products 140-1 of a first manufacturer. Shelf 120-9 is configured to hold the products 140-2 of a second manufacturer. In this case, it may desirable for each shelf 120 to have an active display 300. In this case, the first active display 300-1 displays an advertisement for Coca-Cola®. The second active display 300-2 displays an advertisement for Pepsi®.

FIG. 3 is a perspective view disclosing an embodiment of an active display 300 configured to be attached to the front face 120 of a shelf 110. Active display 300 includes a display surface 320 controlled by a display controller 330. The active display 300 may be mechanically coupled to the front face 120 of a shelf 110 by means of mounting brackets 310.

FIG. 3A discloses a side view of a shelf 110 with an active display 300 mechanically coupled to a front surface 120. This view more particularly discloses the manner in which mounting brackets 310 may help to affix the active display 300 to the shelf 110.

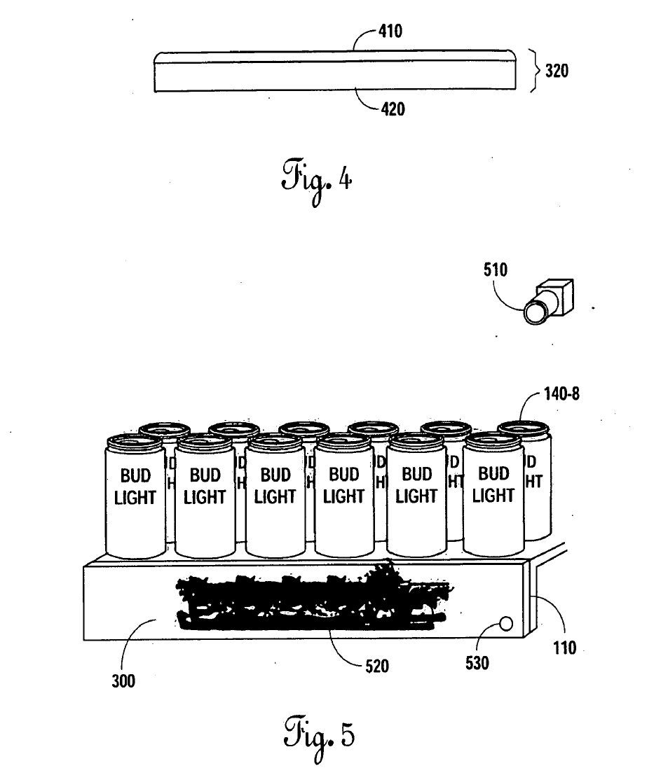

FIG. 4 is a top view of an embodiment of an active display 300 including a display surface 320. The display surface 320 may include a display screen 420, which may employ a known display technology, including, as examples, liquid crystal display (LCD), thin-film transistor LCD (TFT LCD), super-twisted nematic LCD (STN LCD), organic light-emitting diodes (OLED), and interactive touch screen. The display screen 420 may have a width between one-sixteenth inch and one-half inch. A lens assembly 410 may be attached to the front of display screen 420. The lens assembly 410 may be used to magnify the image on the display screen 420.

FIG. 5 discloses an embodiment of how an active display 300 may be used in retail sales. In this case, a camera 510, which may be a video camera, is placed near the active display 300. In this embodiment, active display 300 is affixed to shelf front 120. In this case, the advertised product 140-8 is Bud Light®. Active display 300 may be programmed to display an advertising image 520. In the depicted embodiment, advertising image 520 is an animated image of Clydesdale horses pulling a carriage. More generally, advertising image 520 may be any image or animation promoting the product, the brand, or both. The advertising image 520 may depict a scene, for example, wherein the Clydesdale horses pull the carnage from the right side of the screen to the left. As an additional feature, camera 510 may capture an image of an object such as a consumer (not depicted) standing near the display, and integrate the image of the consumer into the advertising image 520. For example, advertising image 520 may depict the consumer sitting in the carriage and being pulled by the Clydesdale horses. This method may be adapted for use with other brands and products with which particular images are associated. For example, a popular Christmas time advertisement for Coca-Cola® depicts Santa Claus holding or drinking a bottle of Coca-Cola®. In this case, the advertising image 520 may depict Santa Claus holding and drinking Coca-Cola®. As an alternative, the camera 510 may capture an image of a consumer standing near the display, and display an advertising image 520 depicting the consumer as Santa Claus. The advertising image 520 may then be adapted to depict the consumer/Santa Claus holding and drinking the Coca-Cola®. This method may be adapted for other products, whereby the consumer is shown using the product for its intended purpose. In other embodiments, the camera 510 may be a video camera, and may capture a real time image of the consumer and superimpose the consumer's actual motion into the advertising image 520.

A sensor 530 may also be provided to detect the presence of a nearby consumer. The active display 300 may be configured to enter a low-power mode when no consumer is detected, and then wake on an input from the sensor. This allows active display 300 to conserve power when there is no consumer nearby to see the advertising image 520.

In some embodiments, additional features may be provided to appeal to other senses besides sight. For example, an audio track can be added to accompany the animation, in which case a speaker may be integrated into the active display 300. In other embodiments, samples of the product advertised may be provided in conjunction with the multimedia display. This enhances the audio-visual experience with the additional sensations of smell, taste, and touch.

In still other embodiments, display controller 330 may be programmed to receive an image from camera 510 and to perform image processing and/or pattern matching on the image. This may enable display controller 330 to estimate, for example, the age and gender of the consumer. A customized display may then be provided based on the estimate. For example, if an image of the consumer is integrated into the carriage being pulled by Clydesdale horses, appropriate clothing may be selected based on the estimated gender of the consumer. And if the display controller 330 estimates that the consumer is or may be under the legal age, the advertising display may not activate, or may display a public service message discouraging underage drinking.

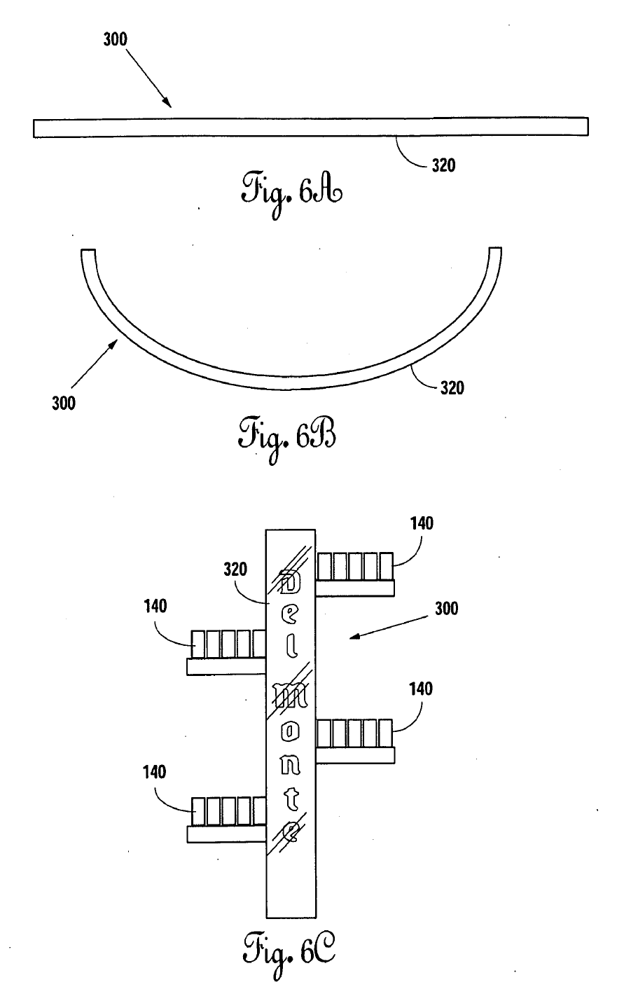

FIGS. 6A, 6B and 6C depict three alternative configurations for an active display 300. In FIG. 6A, the display surface 320 is in a straight rectangular configuration. In FIG. 6B, the display surface 320 is in a curved configuration. In FIG. 6C, the orientation of the display surface 320 is rotated 90 degrees, so that the advertising image is presented in a tabular view.

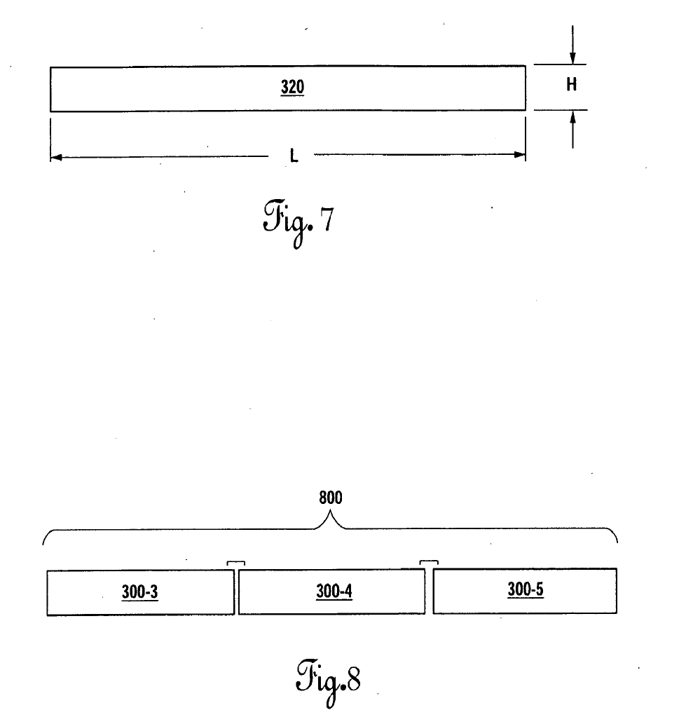

FIG. 7 discloses an exemplary form factor for a high aspect ratio embodiment of active display 300. As used in this disclosure, aspect ratio is defined as the ratio of the longer dimension of display surface 320 to the shorter dimension of display surface 320. In this case, the longer dimension, i.e., the length, is substantially greater than the shorter dimension, i.e., the height. High aspect ratio advertising displays are desirable for their ability to convey effective advertising images while conforming to the size requirements of the available surface. In some embodiments, for example, the aspect ratio of display surface 320 may be 2:1 or greater. In some embodiments, the aspect ratio of display surface 320 is in the range of approximately 2:1 to approximately 36:1. Such an aspect ration may be formed by a screen with a height of one inch and a length in the range of approximately two inches to approximately thirty-six inches.

Since very high aspect ratios may be unsuitable for some graphics processing methods, the advertising image 520 will need to be selected to be suitable for the aspect ratio of the display surface 320. In some embodiments, display controller 330 may be configured to detect the aspect ratio and automatically format the advertising image 520 to be suitable for the display surface. In some cases, the full image may be reproduced, but if the aspect ratio of the original image is substantially different from the aspect ratio of the display surface 320, significant skewing may occur. In such cases, an image may be appropriately cropped to more faithfully reproduce a portion of the image.

FIG. 8 discloses a configuration whereby a number of active displays 300 may be combined to a form a unitized assembly 800 suitable for presenting either three distinct advertising images in close proximity to one another or one integrated advertising image. Each active display 300 may be connected to a single power source, and may be in communication with the others. In the depicted embodiment, active displays 300-3, 300-4 and 300-5 may each be approximately three feet long and may be placed in an end-to-end configuration to form a substantially unitized arrangement. The advertising images displayed on each active display 300-3, 300-4 and 300-5 may be coordinated so that they form what appears to be a substantially single advertising image. In other embodiments, each active display 300 may display an independent advertising image.

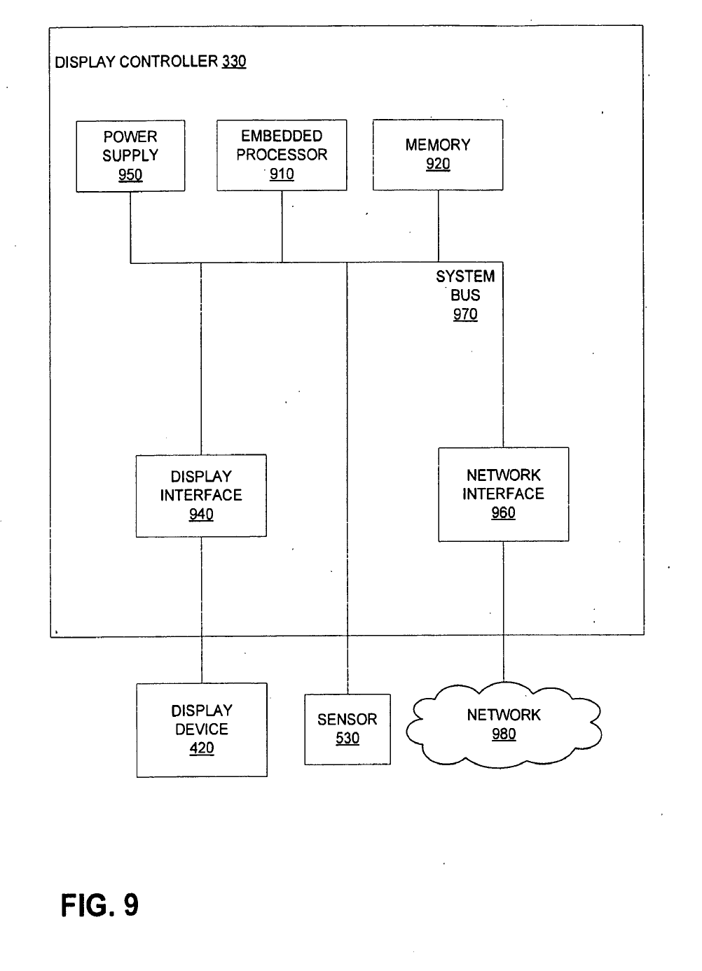

FIG. 9 is a block diagram of selected elements of a display controller 330, which may be used to provide an advertising image 520 (FIG. 5) to display screen 420 of active display 300. In the depicted embodiment, display controller 330 is controlled by an embedded processor 910 which may connect to other components through a system bus 970. System bus 970 may communicatively couple a memory 920, network interface 960, display interface 940, and embedded processor 910. Display controller 330 may also include a power supply 950 to supply power to the various components. Embedded processor 910 may be any type of programmable device, including a microprocessor, a graphics processing unit (GPU), an application-specific integrated circuit (ASIC), a field-programmable gate array (FPGA), or a programmable logic array (PLA). Memory 920 may be programmed or loaded with data representing images to be provided to embedded processor 910. Memory 920 may be any memory device, such as are commonly known in the art, including one or a combination of volatile memory, e.g., random access memory (RAM) and persistent memory or storage including, e.g., flash memory, read only memory (ROM), hard disk drive (HDD) or other magnetic storage, or optical media. Network interface 960 is provided to communicatively couple the display controller 330 to an external network 980. Network interface 960 may be used to program values into memory 920 so as to allow a user to change the advertising image 520 (FIG. 5) that is to be provided to display screen 420. Network interface 960 may provide any of a number of commonly known network interfaces, such as Ethernet, universal serial bus (USB), firewire, RS-232 serial communication, or parallel communication. Display interface 940 is provided to couple the embedded processor 910 to the display screen 420. Display interface 940 may provide any number of known display protocols such as composite audio-video, composite video, component video, and high definition multimedia interface (HDMI).

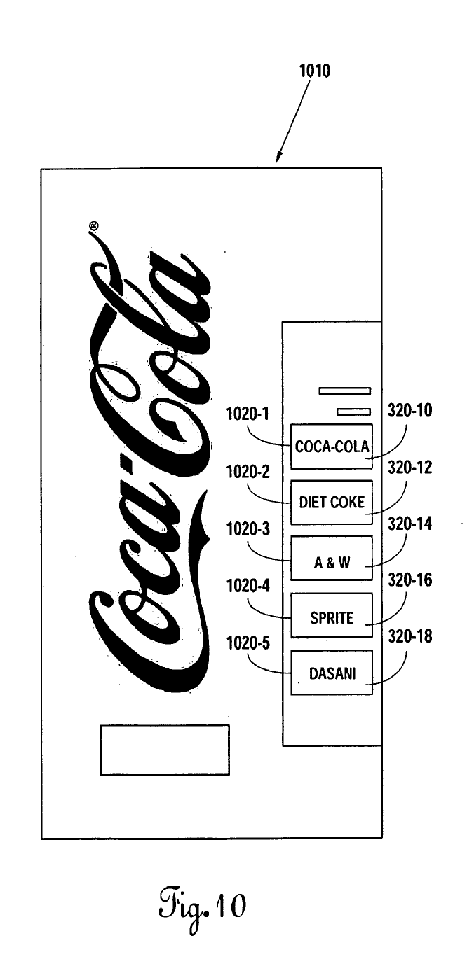

FIG. 10 is a front view of an embodiment of an active display suitable for use with a vending machine. In this case, vending machine 1010 has buttons 1020 for selecting a product. Each of the buttons 1020 may include a display screen 320. In this embodiment, each display screen may be attached to the same display controller 330 (FIG. 3) so that each is part of a single active display 300 (FIG. 3). In other embodiments, each display screen 320 may be part of a separate active display 300 (FIG. 3). This embodiments allows the vending machine to provide active advertisement for the products sold, and also may permit the buttons to be dynamically assigned based on inventory. For example, if the vendor wants to switch from selling A&W® root beer 320-14 to selling Barq's® root beer, the active display 300 (FIG. 3) can be easily changed so that button 1020-3 displays the appropriate advertisement, and the machine can then be stocked with Barq's® root beer.

As described above, an active display 300 may be used to provide a multimedia advertisement for goods. Because the active display 300 is completely self-contained, it does not need to be part of a functioning network to be operable. Rather, it can be programmed through the network interface 960 once, and then operated independently for as long as needed. If the program needs to be changed, it can be easily re-programmed through the network interface 960. This makes the active advertising display disclosed herein both flexible and versatile.

In another embodiment, an active display 300 may be used to form selection buttons on a vending machine. For example, a

The range of products that an active advertising display may be useful for is also broad. This disclosure has primarily disclosed examples of advertisements for food products. But many other products could be advertised, including cosmetics, clothing, jewelry, automotive parts, tools, and hardware. For example, in one embodiment, a camera 510 may capture an image of a woman standing near a cosmetics display. The active display 300 may then enhance the image of the woman's face to show how she would look with the cosmetics applied, and may include an algorithm for suggesting appropriate colors and products.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

What is claimed is:

1. A standalone active display for advertising a product comprising:
a display screen having an aspect ratio of at least 2:1 and a height and length substantially conforming to a height and length of a supporting surface;
a display controller communicatively coupled to the display screen and configured to provide an advertising image to the display screen.

2. The display of claim 1 wherein the display screen is placed in a tabular orientation.

3. The display of claim 1 wherein the length of the display screen is between two inches and thirty-six inches.

4. The display of claim 1 wherein the display screen employs a technology selected from the group consisting of liquid crystal display (LCD), thin film transistor LCD (TFT LCD), super twisted nematic LCD (STN LCD), and organic light-emitting diode (OLED).

5. This display of claim 1 wherein the display controller is configured to change the advertising image at time intervals.

6. The display of claim 1 wherein the advertising image is animated.

7. The display of claim 1 wherein the display controller is configured to receive a signal from a sensor and further configured to activate the advertising image in response to the sensor signal.

8. The display of claim 1 wherein the display screen is curved.

9. The display of claim I wherein the display controller is configured to receive, from a camera, a signal indicative of an image and further configured to integrate the image into the advertising image.

10. The display of claim 9 wherein the image comprises an image of a consumer in proximity to the display screen and wherein the display controller is further configured to provide, to the display screen, a display comprising the image of the consumer interacting with the advertising image.

11. The display of claim 10 wherein the interaction includes the consumer using the product for its intended purpose.

12. The display of claim 1 wherein the aspect ratio is between 2:1 and 36:1.

13. The display of claim 12 wherein the display controller is configured to automatically conform the advertising image to the aspect ratio.

14. The display of claim I wherein the display screen is identified as a first display screen and further comprising a second display screen configured to operate in conjunction with the first display screen.

15. The display of claim 14 wherein the first display screen and second display screen provide a contiguous advertising image.

16. A vending machine employing the display of claim 1 and wherein the supporting surface is a button for selecting the product.

17. A method of advertising a product, the method comprising:
mechanically coupling a display screen to an edge of a display shelf; and
placing a display controller in communication with the display screen, the display controller programmed to provide advertising images to the display screen.

18. The method of claim 17 further comprising:
capturing an image of a consumer in proximity to the display shelf; and
providing the image to the display controller;
wherein the display controller is further programmed to integrate the image of the consumer into the advertising images.

19. The method of claim 18 wherein the display controller is further programmed to allow the image of the consumer to virtually interact with the advertising image.

20. A standalone active display for advertising a product comprising:
a display shelf configured to present the product to a consumer;
a display screen with an aspect ratio between 2:1 and 36:1 and employing a technology selected from the group consisting of liquid crystal display (LCD), thin film transistor (TFT) LCD, super twisted nematic (STN) LCD, and organic light-emitting diode (OLED);
wherein a length and height of the display screen substantially conform to a length and height of an edge of the display shelf;
a display controller to provide animated advertising images to the display screen;
wherein the display controller is configured to receive a signal from a camera placed in a position to capture an image of a consumer in proximity to the active display wherein the signal received by the display controller is indicative of the image;
wherein the display controller is configured to integrate the image of the consumer into the animated advertising image and produce a display sequence featuring the image of the user interacting with the animated advertising image, including the image of the consumer using the product in at least one of its intended purposes.
